(19) United States
(12) Patent Application Publication
(10) Pub. No.: US 2020/0088524 A1
(43) Pub. Date: Mar. 19, 2020

(54) AIRPORT GUIDE ROBOT AND OPERATION METHOD THEREFOR

(71) Applicant: LG ELECTRONICS INC., Seoul (KR)

(72) Inventors: Yongmin SHIN, Seoul (KR); Hyoungrock KIM, Seoul (KR); Kanguk KIM, Seoul (KR); Donghoon KIM, Seoul (KR)

(21) Appl. No.: 16/340,295

(22) PCT Filed: Sep. 22, 2017
(86) PCT No.: PCT/KR2017/010440

§ 371 Date: Apr. 8, 2019

(30) Foreign Application Priority Data
Oct. 10, 2016 (KR) 10-2016-0130735

(51) Int. Cl. G01C 21/20; H04N 7/18; G06K 9/00

(52) U.S. Cl. CPC G01C 21/206; G06K 9/00805; H04N 7/18

(57) ABSTRACT

A guidance robot comprising: a map management module configured to store map data; a camera configured to capture an image; a communication interface configured to transmit or receive data; an imaging processor configured to process an image; a display configured to display the image processed by the imaging processor; a motor configured to generate a force to move the guidance robot; and a controller configured to control an operation of the guidance robot, wherein in respond to receiving a road guidance request signal, the controller is to control the camera, the display to display a real-time image of a region of a movement path captured by the camera while moving along a determined movement path from a current position to a destination position, based on the map data.

### TECHNICAL FIELD

The present invention relates to a robot disposed at airport and an operating method of the robot. In more detail, the present invention provides a guidance robot for airport, which is disposed at airport to provide users with a destination road guidance service. The present invention relates to a guidance robot for airport, which displays an omnidirectional region screen while accompanying users up to an actual destination.

### BACKGROUND ART

Recently, as deep learning technology, self-driving technology, automatic control technology, and Internet of things (IoT) advance, it is possible to implement intelligent robots. Intelligent robots are disposed at public places such as airport, and thus, it is possible to provide users with various information and services.

Each technology will be described below in detail. Deep learning corresponds to the field of machine learning. The deep learning is technology which allows a program to perform similar determination on various situations, instead of a method where a condition and a command are previously set in a program. Therefore, according to the deep learning, computers may think similar to brains of humans and may analyze massive data.

Self-driving is technology where a machine determines and moves autonomously to avoid an obstacle. According to the self-driving technology, a robot autonomously recognizes and moves a position through a sensor to avoid an obstacle.

The automatic control technology denotes technology where a machine feeds back a measurement value, obtained by inspecting a machine state, to a control device to automatically control an operation of the machine. Therefore, control may be performed without manipulation by a user, and control may be automatically performed so that a desired control target reaches a desired range.

IoT denotes intelligent technology and service where all things are connected to one another over Internet and information exchanges between a user and a thing and between a thing and a thing. Devices connected to Internet through IoT transmit or receive information to perform autonomous communication, without the help of a user.

Intelligent robots may be implemented with the advance and emergence of the above-described technologies, and it is possible to provide various information and services through intelligent robots.

The application fields of robots are generally classified into industrial robots, medical robots, universal robots, and seabed robots. For example, in machine processing industry such as production of vehicles, robots may perform an iterative work. That is, industrial robots which learn an operation performed by arms of persons once and repeat the same operation for much time are being applied.

Moreover, technology where a camera is equipped in a robot has been implemented. Robots may check a position or may recognize an obstacle by using a camera. Also, technology for displaying a captured image on a display unit is being sufficiently implemented.

### DISCLOSURE

### Technical Problem

An object of the present invention is to prevent a field of view of a user from being disturbed when providing a road guidance service while accompanying a robot for airport.

Another object of the present invention is to effectively provide a road guidance service to users at airport having a complicated geographic condition.

Another object of the present invention is to prevent a robot for airport from missing a user when providing a road guidance accompanying service.

### Technical Solution

A guidance robot for airport according to the present invention may include a camera and a display unit. The guidance robot for airport may display an omnidirectional region image photographed by the camera. A following user may check the omnidirectional image displayed on the display unit.

A guidance robot for airport according to the present invention may display navigation content based on a movement path on a display unit. A following user may check the navigation content displayed by the display unit.

A guidance robot for airport according to the present invention may receive real-time CCTV photographing image data obtained by photographing a periphery of a destination. Also, the guidance robot for airport may display CCTV photographing image data, obtained by photographing the periphery of the destination, on a display unit. Furthermore, the guidance robot for airport may mix the CCTV photographing image data with main facilities data of the periphery of the destination to display mixed data on the display unit.

A guidance robot for airport according to the present invention may sense in real time a distance between a following user and the guidance robot by using a camera or a sensor. Also, the guidance robot may control a movement speed depending on the case.

### Advantageous Effects

A guidance robot for airport according to the present invention may display a front region image, captured by a camera, on a display unit. Also, a following user may check the front region image, thereby obtaining an effect of solving a problem where a field of front view is occluded by the robot.

The guidance robot for airport according to the present invention may provide an accompanying service, and simultaneously, may provide navigation content. As a result, an effect where a following user can easily check a path through which the user is currently moving is obtained.

The guidance robot for airport according to the present invention may mix CCTV photographing image data with main facilities data of a periphery of a destination to output mixed data through the display unit. As a result, there is an effect where a user can easily check actual destination periphery information and may effectively visit main facilities.

The guidance robot for airport according to the present invention may sense a distance to a user in real time to always maintain a certain distance. As a result, an effect of preventing an error where the robot misses a user in providing the road guidance accompanying service is obtained.

### DESCRIPTION OF DRAWINGS

FIG. 1 is a block diagram illustrating a hardware configuration of an airport robot according to an embodiment of the present invention.

FIG. 2 is a diagram illustrating in detail a configuration of each of a microcomputer and an application processor (AP) of an airport robot according to another embodiment of the present invention.

FIG. 3 is a diagram illustrating the structure of an airport robot system according to an embodiment of the present invention.

FIG. 4 is a diagram for describing an example where a guidance robot according to an embodiment of the present invention photographs an omnidirectional image at airport by using an omnidirectional camera.

FIGS. 5 to 8 are diagrams for describing an omnidirectional camera equipped in a guidance robot according to an embodiment of the present invention.

FIGS. 9 and 10 are diagrams for describing an example where a guidance robot according to an embodiment of the present invention displays some images, photographed by an omnidirectional camera, on a display unit.

FIGS. 11 to 13 are diagrams for describing an example where a guidance robot according to an embodiment of the present invention receives a CCTV image to display the CCTV image on a display unit.

FIGS. 14 to 18 are diagrams for describing an example where a guidance robot according to an embodiment of the present invention always moves while maintaining a certain distance to a user, a wall, and a floor.

FIGS. 19 to 21 are diagrams for describing an example where guidance robots according to an embodiment of the present invention provide a road guidance accompanying service by units of regions.

FIG. 22 is a block diagram illustrating a configuration of a guidance robot for airport according to an embodiment of the present invention.

### MODE FOR INVENTION

Hereinafter, embodiments relating to the present invention will be described in detail with reference to the accompanying drawings. The suffixes “module” and “unit” for components used in the description below are assigned or mixed in consideration of easiness in writing the specification and do not have distinctive meanings or roles by themselves.

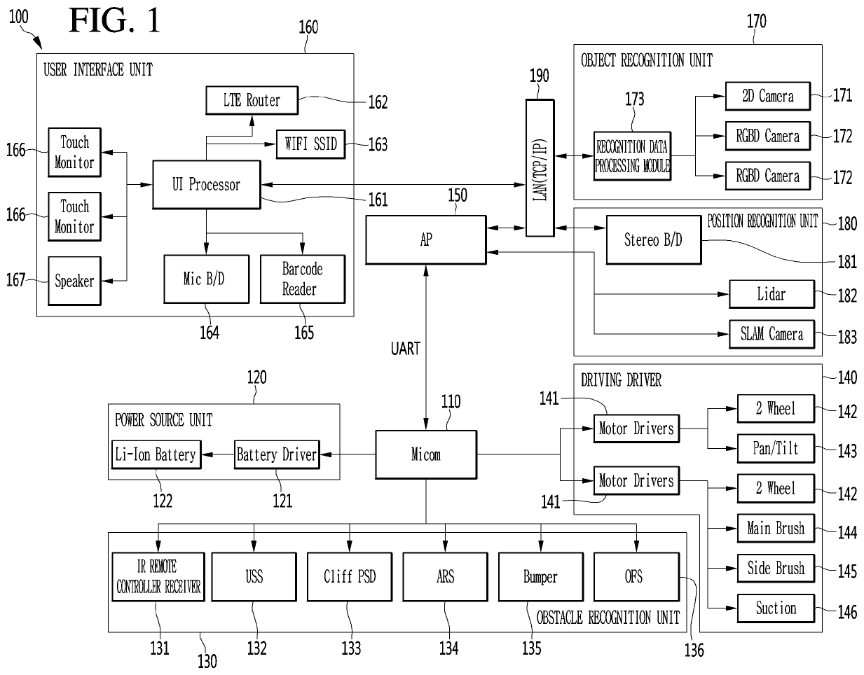

FIG. 1 is a block diagram illustrating a hardware configuration of an airport robot according to an embodiment of the present invention.

As illustrated in FIG. 1, hardware of the airport robot according to an embodiment of the present invention may be configured with a microcomputer group and an AP group. The microcomputer group may include a microcomputer 110, a power source unit 120, an obstacle recognition unit 130, and a driving driver 140. The AP group may include an AP 150, a user interface unit 160, an object recognition unit 170, a position recognition unit 180, and a local area network (LAN) 190.

The microcomputer 110 may manage the power source unit 120 including a battery of the hardware of the airport robot, the obstacle recognition unit 130 including various kinds of sensors, and the driving driver 140 including a plurality of motors and wheels.

The power source unit 120 may include a battery driver 121 and a lithium-ion (li-ion) battery 122. The battery driver 121 may manage charging and discharging of the li-ion battery 122. The li-ion battery 122 may supply power for driving the airport robot. The li-ion battery 122 may be configured by connecting two 24V/102A li-ion batteries in parallel.

The obstacle recognition unit 130 may include an infrared (IR) remote controller receiver 131, an ultrasonic sensor (USS) 132, a cliff PSD 133, an attitude reference system (ARS) 134, a bumper 135, and an optical flow sensor (OFS) 136. The IR remote controller receiver 131 may include a sensor which receives a signal from an IR remote controller for remotely controlling the airport robot. The USS 132 may include a sensor for determining a distance between an obstacle and the airport robot by using an ultrasonic signal. The cliff PSD 133 may include a sensor for sensing a precipice or a cliff within a forward-direction airport robot driving range of 360 degrees. The ARS 134 may include a sensor for detecting a gesture of the airport robot. The ARS 134 may include a sensor which is configured with an acceleration 3-axis and a gyro 3-axis for detecting the number of rotations. The bumper 135 may include a sensor which senses a collision between the airport robot and an obstacle. The sensor included in the bumper 135 may sense a collision between the airport robot and an obstacle within a 360-degree range. The OFS 136 may include a sensor for measuring a phenomenon where a wheel is spinning in driving of the airport robot and a driving distance of the airport robot on various floor surfaces.

The driving driver 140 may include a motor driver 141, a wheel motor 142, a rotation motor 143, a main brush motor 144, a side brush motor 145, and a suction motor 146. The motor driver 141 may perform a function of driving the wheel motor, the brush motor, and suction motor for driving and cleaning of the airport robot. The wheel motor 142 may drive a plurality of wheels for driving of the airport robot. The rotation motor 143 may be driven for a lateral rotation and a vertical rotation of a head unit of the airport robot or a main body of the airport robot, or may be driven the direction change or rotation of a wheel of the airport robot. The main brush motor 144 may drive a brush which sweeps filth on an airport floor. The side brush motor 145 may drive a brush which sweeps filth in a peripheral area of an outer surface of the airport robot. The suction motor 146 may be driven for sucking filth on the airport floor.

The AP 150 may function as a central processing unit which manages a whole hardware module system of the airport robot. The AP 150 may transmit, to the microcomputer 110, user input/output information and application program driving information for driving by using position information obtained through various sensors, thereby allowing a motor or the like to be performed.

The user interface unit 160 may include a user interface (UI) processor 161, a long term evolution (LTE) router 162, a WIFI SSID 163, a microphone board 164, a barcode reader 165, a touch monitor 166, and a speaker 167. The user interface processor 161 may control an operation of the user interface unit which performs an input/output of a user. The LTE router 162 may receive necessary information from the outside and may perform LTE communication for transmitting information to the user. The WIFI SSID 163 may analyze WIFI signal strength to perform position recognition on a specific object or the airport robot. The microphone board 164 may receive a plurality of microphone signals, process a sound signal into sound data which is a digital signal, and analyze a direction of the sound signal and a corresponding sound signal. The barcode reader 165 may read barcode information described in a plurality of targets used in airport. The touch monitor 166 may include a monitor for displaying output information and a touch panel which is configured for receiving the input of the user. The speaker 167 may inform the user of specific information through a voice.

The object recognition unit 170 may include a two-dimensional (2D) camera 171, a red, green, blue, and distance (RGBD) camera 172, and a recognition data processing module 173. The 2D camera 171 may be a sensor for recognizing a person or an object on the basis of a 2D image. The RGBD camera 172 may be a camera including RGBD sensors or may be a sensor for detecting a person or an object by using captured images including depth data obtained from other similar three-dimensional (3D) imaging devices. The recognition data processing module 173 may process a signal such as 2D image/video or 3D image/video obtained from the 2D camera and the RGBD camera 172 to recognize a person or an object.

The position recognition unit 180 may include a stereo board (B/D) 181, a light detection and ranging (LIDAR) 182, and a simultaneous localization and mapping (SLAM) camera 183. The SLAM camera 183 may implement simultaneous position tracing and mapping technology. The airport robot may detect ambient environment information by suing the SLAM camera 183 and may process obtained information to generate a map corresponding to a duty performing space and simultaneously estimate its absolute position. The LIDAR 182, a laser radar, may be a sensor which irradiates a laser beam and collects and analyzes rearward-scattered light of light absorbed or scattered by aerosol to perform position recognition. The stereo board 181 may process sensing data collected from the LIDAR 182 and the SLAM camera 183 to manage data for recognizing a position of the airport robot and an obstacle.

The LAN 190 may perform communication with the user interface processor 161 associated with a user input/output, the recognition data processing module 173, the stereo board 181, and the AP 150.

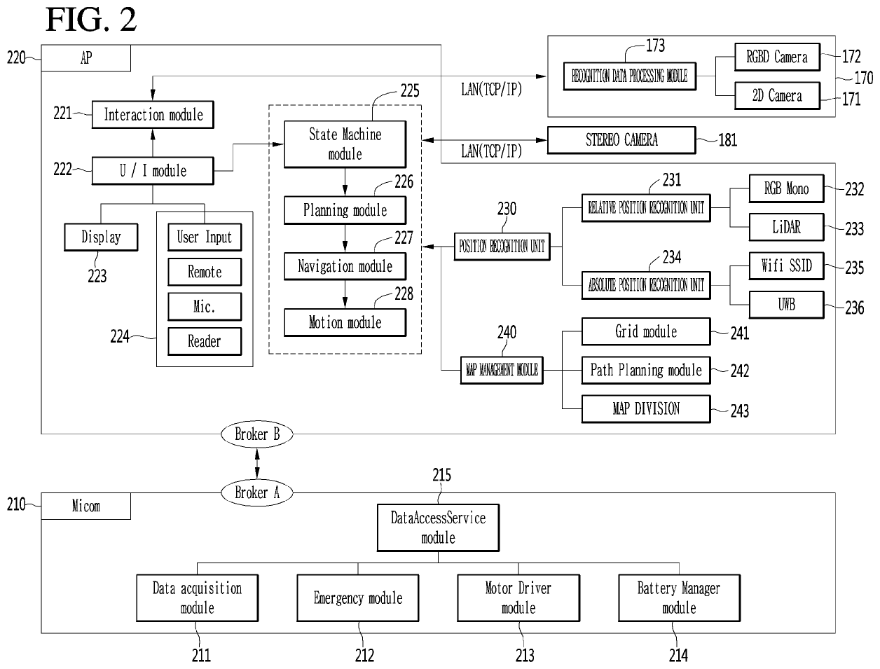

FIG. 2 is a diagram illustrating in detail a configuration of each of a microcomputer and an AP of an airport robot according to another embodiment of the present invention.

As illustrated in FIG. 2, a microcomputer 210 and an AP 220 may be implemented as various embodiments, for controlling recognition and action of the airport.

For example, the microcomputer 210 may include a data access service module 215. The data access service module 215 may include a data acquisition module 211, an emergency module 212, a motor driver module 213, and a battery manager module 214. The data acquisition module 211 may acquire data sensed from a plurality of sensors included in the airport robot and may transfer the acquired data to the data access service module 215. The emergency module 212 may be a module for sensing an abnormal state of the airport robot, and when the airport robot performs a predetermined type action, the emergency module 212 may sense that the airport robot is in the abnormal state. The motor driver module 213 may manage a wheel, a brush, and driving control of a suction motor for driving and cleaning of the airport robot. The battery manager module 214 may manage charging and discharging of the li-ion battery 122 of FIG. 1 and may transfer a battery state of the airport robot to the data access service module 215.

The AP 220 may receive, recognize, and process a user input and the like to control an operation of the airport robot with various cameras and sensors. An interaction module 221 may be a module which synthesizes recognition data received from the recognition data processing module 173 and a user input received from a user interface module 222 to manage software exchanged between a user and the airport robot. The user interface module 222 may receive a close-distance command of the user such as a key, a touch screen, a reader, and a display unit 223 which is a monitor for providing manipulation/information and a current situation of the airport robot, or may receive a long-distance signal such as a signal of an IR remote controller for remotely controlling the airport robot, or may manage a user input received of a user input unit 224 receiving an input signal of the user from a microphone, a barcode reader, or the like. When one or more user inputs are received, the user interface module 222 may transfer user input information to a state machine module 225. The state machine module 225 which has received the user input information may manage a whole state of the airport robot and may issue an appropriate command corresponding to a user input. A planning module 226 may determine a start time and an end time/action for a specific operation of the airport robot according to the command transferred from the state machine module 225 and may calculate a path through which the airport will move. A navigation module 227 may be a module which manages overall driving of the airport robot and may allow the airport robot to drive along a driving path calculated by the planning module 226. A motion module 228 may allow the airport robot to perform a basic operation in addition to driving.

Moreover, the airport robot according to another embodiment of the present invention may include a position recognition unit 230. The position recognition unit 230 may include a relative position recognition unit 231 and an absolute position recognition unit 234. The relative position recognition unit 231 may correct a movement amount of the airport robot through an RGM mono sensor 232, calculate a movement amount of the airport robot for a certain time, and recognize an ambient environment of the airport robot through a LIDAR 233. The absolute position recognition unit 234 may include a WIFI SSID 235 and a UWB 236. The WIFI SSID 235 may be an UWB sensor module for recognizing an absolute position of the airport robot and may be a WIFI module for estimating a current position through WIFI SSID sensing. The WIFI SSID 235 may analyze WIFI signal strength to recognize a position of the airport robot. The UWB 236 may calculate a distance between a transmission unit and a reception unit to sense the absolute position of the airport robot.

Moreover, the airport robot according to another embodiment of the present invention may include a map management module 240. The map management module 240 may include a grid module 241, a path planning module 242, and a map division module 243. The grid module 241 may manage a lattice type map generated by the airport robot through an SLAM camera or map data of an ambient environment, previously input to the airport robot, for position recognition. In map division for cooperation between a plurality of airport robots, the path planning module 242 may calculate driving paths of the airport robots. Also, the path planning module 242 may calculate a driving path through which the airport robot will move. Also, the path planning module 242 may calculate a driving path through which the airport robot will move in an environment where one airport robot operates. The map division module 243 may calculate in real time an area which is to be managed by each of a plurality of airport robots.

Pieces of data sensed and calculated from the position recognition unit 230 and the map management module 240 may be again transferred to the state machine module 225. The state machine module 225 may issue a command to the planning module 226 so as to control an operation of the airport robot, based on the pieces of data sensed and calculated from the position recognition unit 230 and the map management module 240.

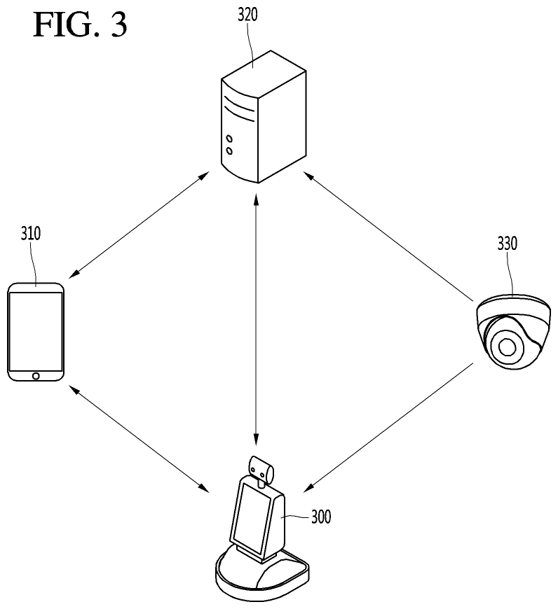

FIG. 3 is a diagram illustrating the structure of an airport robot system according to an embodiment of the present invention.

The airport robot system according to the embodiment of the present invention may include a mobile terminal 310, a server 320, an airport robot 300, and a camera 330.

The mobile terminal 310 may transmit and receive data to and from the server 320 in the airport. For example, the mobile terminal 310 may receive airport related data such as a flight time schedule, an airport map, etc. from the server 320. A user may receive necessary information of the airport from the server 320 through the mobile terminal 310. In addition, the mobile terminal 310 may transmit data such as a photo, a moving image, a message, etc. to the server 320. For example, the user may transmit the photograph of a missing child to the server 320 to report the missing child or photograph an area of the airport where cleaning is required through the camera to request cleaning of the area.

In addition, the mobile terminal 310 may transmit and receive data to and from the airport robot 300.

For example, the mobile terminal 310 may transmit, to the airport robot 300, a signal for calling the airport robot 300, a signal for instructing that specific operation is performed, or an information request signal. The airport robot 300 may move to the position of the mobile terminal 310 or perform operation corresponding to the instruction signal in response to the call signal received from the mobile terminal 310. Alternatively, the airport robot 300 may transmit data corresponding to the information request signal to the mobile terminal 310 of the user.

The airport robot 300 may perform patrol, guidance, cleaning, disinfection and transportation within the airport.

The airport robot 300 may transmit and receive signals to and from the server 320 or the mobile terminal 310. For example, the airport robot 300 may transmit and receive signals including information on the situation of the airport to and from the server 320. In addition, the airport robot 300 may receive image information of the areas of the airport from the camera 330 in the airport. Accordingly, the airport robot 300 may monitor the situation of the airport through the image information captured by the airport robot 300 and the image information received from the camera 330.

The airport robot 300 may directly receive a command from the user. For example, a command may be directly received from the user through input of touching the display unit provided in the airport robot 300 or voice input. The airport robot 300 may perform patrol, guidance, cleaning, etc. according to the command received from the user, the server 320, or the mobile terminal 310.

Next, the server 320 may receive information from the airport robot 300, the camera 330, and/or the mobile terminal 310. The server 320 may collect, store and manage the information received from the devices. The server 320 may transmit the stored information to the airport robot 300 or the mobile terminal 310. In addition, the server 320 may transmit command signals to a plurality of the airport robots 300 disposed in the airport.

The camera 330 may include a camera installed in the airport. For example, the camera 330 may include a plurality of closed circuit television (CCTV) cameras installed in the airport, an infrared thermal-sensing camera, etc. The camera 330 may transmit the captured image to the server 320 or the airport robot 300.

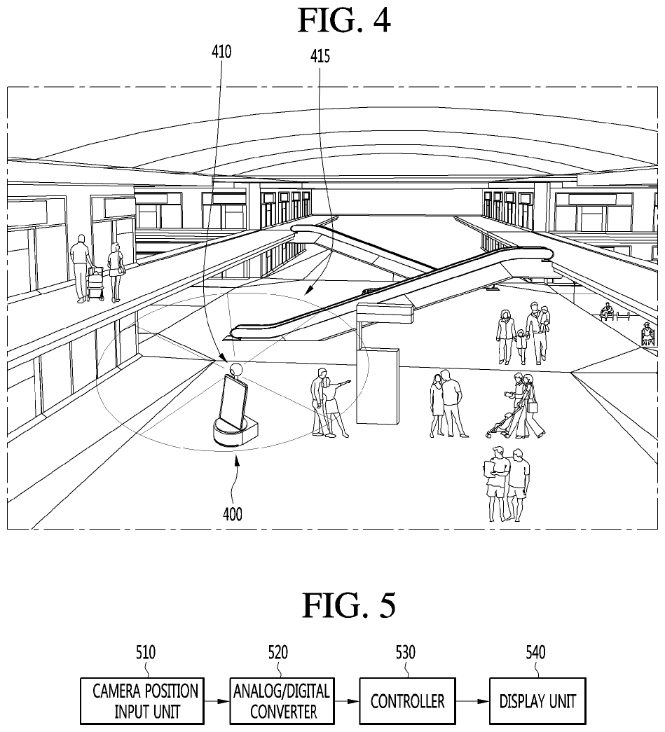

FIG. 4 is a diagram for describing an example where a guidance robot according to an embodiment of the present invention photographs an omnidirectional image at airport by using an omnidirectional camera.

The guidance robot according to an embodiment of the present invention may photograph and store an image within a predetermined range by using an omnidirectional camera while perambulating a certain region of airport.

For example, as illustrated in FIG. 4, a guidance robot 400 may be equipped with an omnidirectional camera 410 on a display unit. The omnidirectional camera 410 may be referred to as a 360-degree camera. The omnidirectional camera 410 may photograph an image of a 360-degree region (i.e., an omnidirectional image 415) at a predetermined distance. The omnidirectional camera 410 will be described below in detail with reference to FIGS. 5 to 8.

FIGS. 5 to 8 are diagrams for describing an omnidirectional camera equipped in a guidance robot according to an embodiment of the present invention.

In the omnidirectional camera 410, some products equipped with an internal camera may use a rotary camera and may rotate the rotary camera to photograph an object. The omnidirectional camera 410 equipped with the rotary camera, as illustrated in FIG. 5, may include: a camera position input unit 510 configured to output an analog signal representing a relative position of a camera; an analog/digital converter 520 configured to digital-convert and output the analog signal; a controller 530 configured to determine the relative position of the camera with reference to digital-converted data; and a display unit 540 configured to display an operating state of the controller 530.

The camera position input unit 510 mat transfer a signal, representing a relative position of a camera, to the controller 530, and the controller 530 may check the relative position of the camera and may perform an operation corresponding thereto. The camera position input unit 510 may have a different configuration for each omnidirectional camera 410.

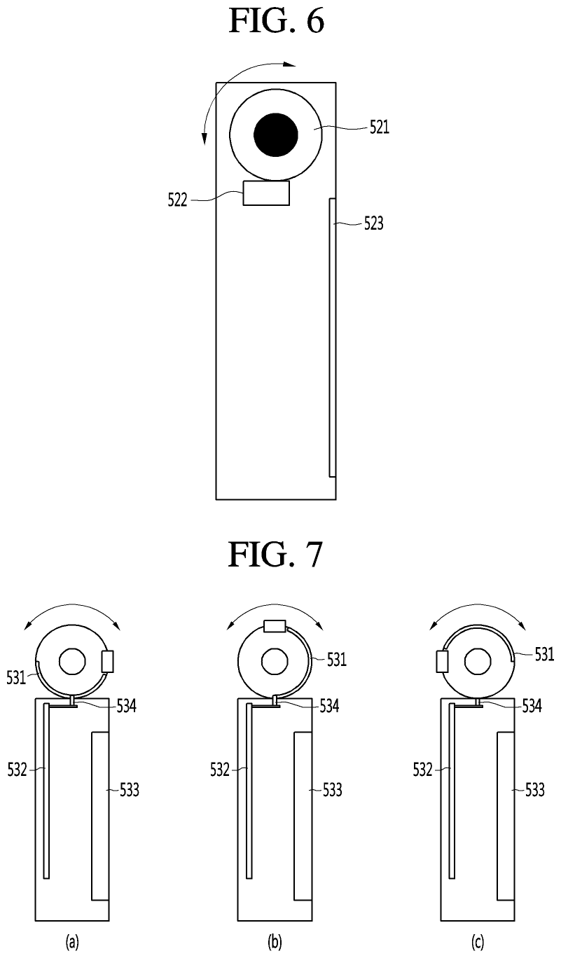

FIG. 6 is an exemplary diagram illustrating a configuration of a rotation angle recognition device of a rotary camera capable of being included in the omnidirectional camera 410, and as illustrated therein, the rotation angle recognition device may be configured with: a rotary camera 521 configured to rotate at a certain angle; and a camera position signal output unit 522 configured to output an analog signal based on a relative position of the rotary camera 521.

The rotary camera 521 may photograph an image while rotating at a certain angle within 360 degrees and may transfer the image to a controller, and the display unit 523 may display the image. The camera position signal output unit 522 may output an analog signal, representing a relative position of the rotary camera 521, to the controller to allow the controller to determine the relative position of a camera.

FIG. 7 is an exemplary diagram describing a device for recognizing the rotation or not of the rotary camera of FIG. 6, and as illustrated therein, when a camera rotates at a certain angle, a vertical movement of a switch 531 is described and the switch 531 may be turned on/off, thereby outputting a high/low signal representing a relative position of a camera to a controller.

When the switch 531 is located in a groove 534 of a rotation plate, the switch 531 is turned off, and thus, the camera position signal output unit outputs a high signal to the controller. On the other hand, when the switch is located in a portion where the groove 534 is not formed, the switch is turned on, and thus, a low signal is output. In a structure of the omnidirectional camera 410, in a case where the camera is initially set to perform photographing with respect to a state of facing a front region, when the camera rotates to face a rear region, an image displayed by the display unit is shown in a turned state. In order to correct this, a user may perform manual manipulation to correct a vertically turned image.

Moreover, a mechanism configuration for turning on/off the switch according to a position of a rotation plate groove is simple, but durability and stability may be reduced due to wear caused by friction.

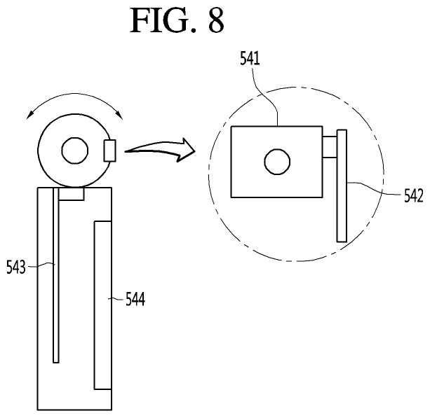

FIG. 8 is an exemplary diagram illustrating a configuration of a rotation angle recognition device of a rotary camera included in an omnidirectional camera of the present invention, and as illustrated therein, the rotation angle recognition device may be configured with: a camera 541 configured to rotate at a certain angle; a voltage output unit 542 connected to a rotation shaft of the camera 541 and configured to divide and output a source voltage, based on a variable resistor having a resistance value varying through rotation and a fixed resistor having a constant resistance value; and a controller 543 configured to digital-convert a voltage value of the voltage output unit 542 to calculate a rotation speed of the camera, and control displaying of an image corresponding to a rotation angle.

The camera 541 rotates at a certain angle within a 360-degree range and is connected to a rotation shaft of a camera module and a rotation shaft of a variable resistor 542. When the camera 541 rotates, the rotation shaft of the variable resistor 542 may rotate, and thus, a resistance value of the variable resistor 542 may vary. The voltage output unit 542 may divide the source voltage, based on the variable resistor having a resistance value varying through rotation of the camera and the fixed resistor having a constant resistance value, thereby outputting a certain voltage value.

The controller 543 may digital-convert a voltage value of the voltage output unit 542 by using the analog/digital convert to calculate a rotation angle of the camera and may control displaying of an image corresponding to the rotation angle. When the rotation angle of the camera 541 is equal to or greater than a predetermined reference angle, the controller 543 may determine the image turn of the display unit 544 and may correct an input image of the camera 541.

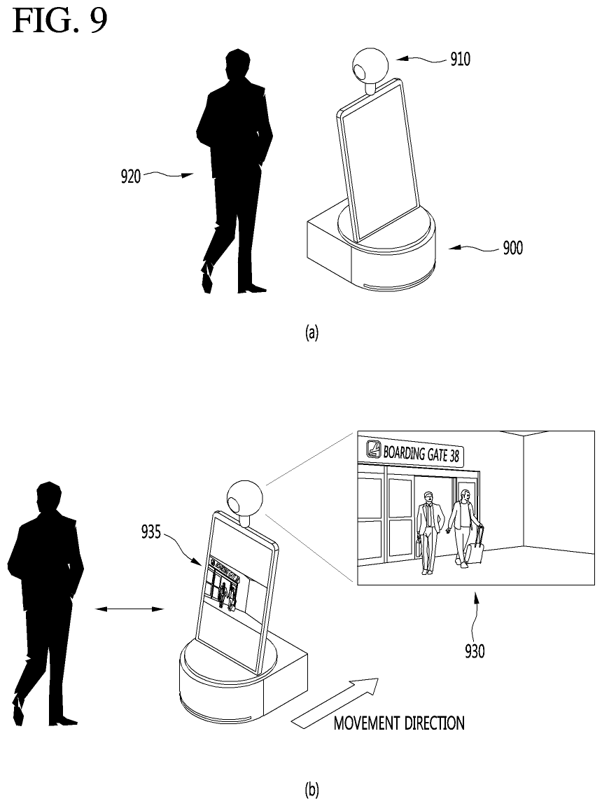

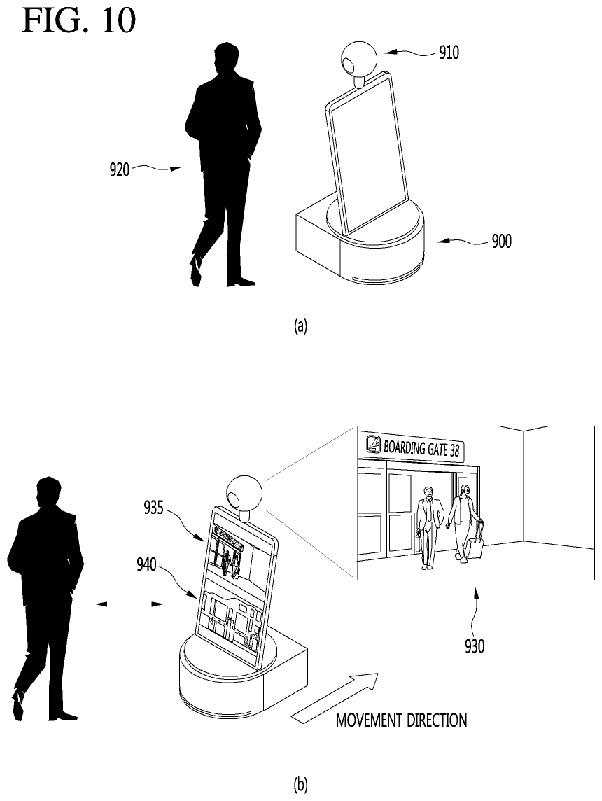

FIGS. 9 and 10 are diagrams for describing an example where a guidance robot according to an embodiment of the present invention displays some images, photographed by an omnidirectional camera, on a display unit.

The guidance robot according to an embodiment of the present invention may provide a road guidance accompanying service to a user at airport. That is, the user may request a road guidance service from a current position to a specific destination from a guidance robot at airport. The guidance robot may provide a road guidance display service which informs the user of a movement path from the current position to the specific destination through a map or a navigation. In addition, the guidance robot may provide the user with the road guidance accompanying service guiding a road while directly accompanying the user from the current position to the specific destination. In this case, the guidance robot may display a certain region, included in an image photographed by the omnidirectional camera, on the display unit.

For example, as illustrated in FIG. 9, a user 920 may request a road guidance service from a guidance robot 900. Also, the guidance robot 900 may provide a road guidance accompanying service to the user 920 at airport. The guidance robot 900 may provide a road guidance display service which informs the user 920 of a movement path from a current position to a specific destination through a map or a navigation. In addition, the guidance robot 900 may provide the user with the road guidance accompanying service guiding a road while directly accompanying the user from the current position to the specific destination.

In this case, the guidance robot 900 may display a certain region, included in an image photographed by the omnidirectional camera 910, on the display unit. For example, as illustrated in FIG. 9, the guidance robot 900 may display an image 935, obtained by photographing a region including a front region with respect to a movement direction, on the display unit. Therefore, in a case where the user 920 is provided with the road guidance accompanying service, inconvenience where a field of front view is occluded by the guidance robot 900 may be solved.

Moreover, as illustrated in FIG. 10, the guidance robot 900 may allow the display unit to display second content 940 providing a road guidance display service such as a map image or a navigation, in addition to first content such as an image 935 of a certain region photographed by the omnidirectional camera 910.

Moreover, the guidance robot 900 may include a user interface such as a touch pad in the display unit. Also, the user 920 may change the second content in a method of touching the display unit of the guidance robot 900. For example, the second content may be a navigation image displaying a movement path which enables movement to a destination. Also, when the user 920 touches the display unit of the guidance robot 900, the second content may be changed to a guidance image corresponding to main facilities at airport. Also, when the user 920 again touches the display unit of the guidance robot 900, the second content may be changed to content associated with the destination. Also, when the user 920 again touches the display unit of the guidance robot 900, a navigation image displaying a movement path which enables movement to the destination may be again output as the second content.

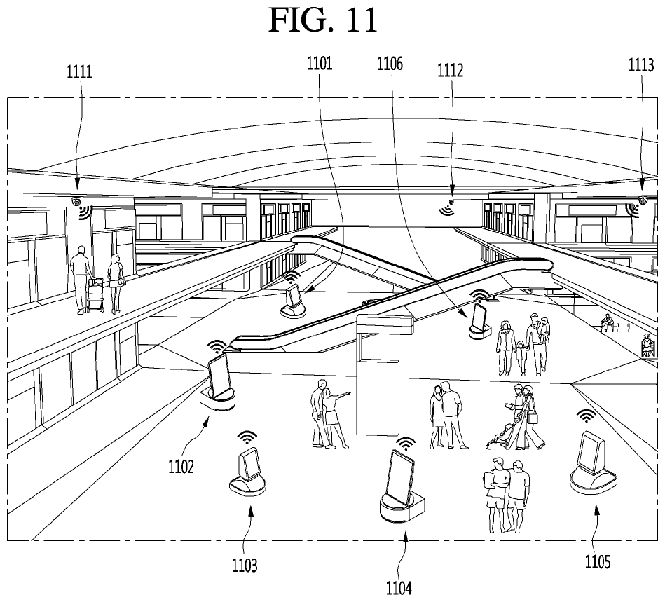

FIGS. 11 to 13 are diagrams for describing an example where a guidance robot according to an embodiment of the present invention receives a CCTV image to display the CCTV image on a display unit.

As illustrated in FIG. 11, a plurality of CCTVs 1111 to 1113 may be randomly disposed at airport. The plurality of CCTVs 1111 to 1113 may photograph an internal situation of the airport in real time. Also, the plurality of CCTVs 1111 to 1113 may transmit real-time photographing image data to one or more airport robots 1101 to 1106. The one or more airport robots 1101 to 1106 may provide various services to an airport user by using the image data transferred from the CCTV. Also, the plurality of CCTVs 1111 to 1113 may transmit the real-time photographing image data to a server. Also, the one or more airport robots 1101 to 1106 may receive real-time photographing image data, photographed by a specific CCTV, from the server.

Moreover, when the guidance robot according to an embodiment of the present invention provides a road guidance accompanying service to a user, the guidance robot may receive and output real-time photographing image data photographed by a CCTV. At this time, the guidance robot may process the real-time photographing image data photographed by the CCTV and may display processed image data on the display unit.

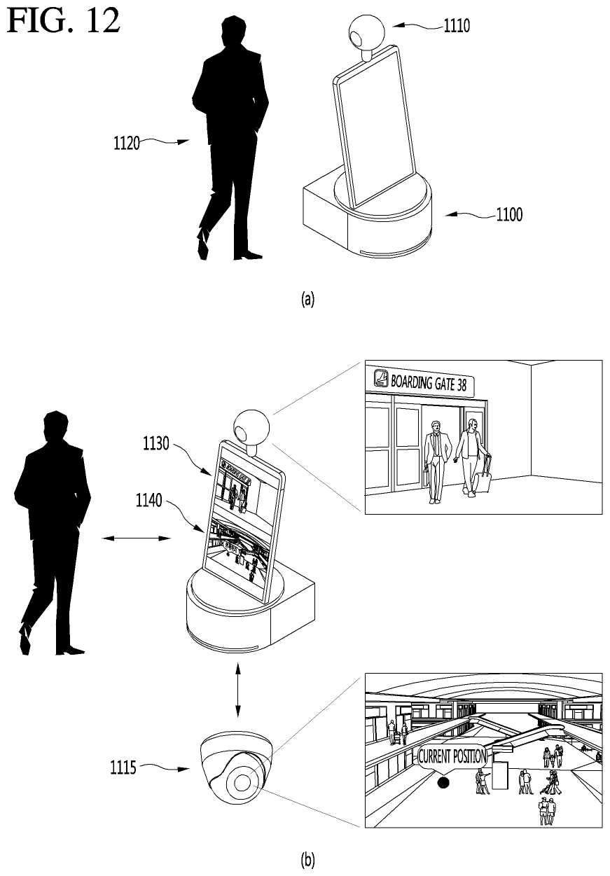

For example, as illustrated in FIG. 12, a user 1120 may request a road guidance service to a guidance robot 1100. Also, the guidance robot 1100 may provide a road guidance accompanying service to the user 1120 at airport. The guidance robot 1100 may provide a road guidance display service which informs the user 1120 of a movement path from a current position to a specific destination through a map or a navigation. In addition, the guidance robot 1100 may provide the user with the road guidance accompanying service guiding a road while directly accompanying the user from the current position to the specific destination.

In this case, the guidance robot 1100 may display a certain region, included in an image photographed by an omnidirectional camera 1110, on the display unit. For example, as illustrated in FIG. 12, the guidance robot 1100 may display an image 1130, obtained by photographing a region including a front region with respect to a movement direction, on the display unit. Therefore, in a case where the user 1120 is provided with the road guidance accompanying service, inconvenience where a field of front view is occluded by the guidance robot 1100 may be solved.

Moreover, as illustrated in FIG. 12, the guidance robot 1100 may process data of a real-time photographing image 1140 photographed the CCTV 1115, in addition to first content such as an image 1130 of a certain region photographed the omnidirectional camera 1110 and may display processed data on the display unit. At this time, the guidance robot 1100 may perform an image data processing process of adding an indicator representing a position of the current user 1120 in a real-time photographing image 1140 photographed by the CCTV 1115. Therefore, in providing a road guidance accompanying service, the guidance robot 1100 may output, through the display unit, an image photographed the omnidirectional camera 1110 and an image photographed by the CCTV 1115.

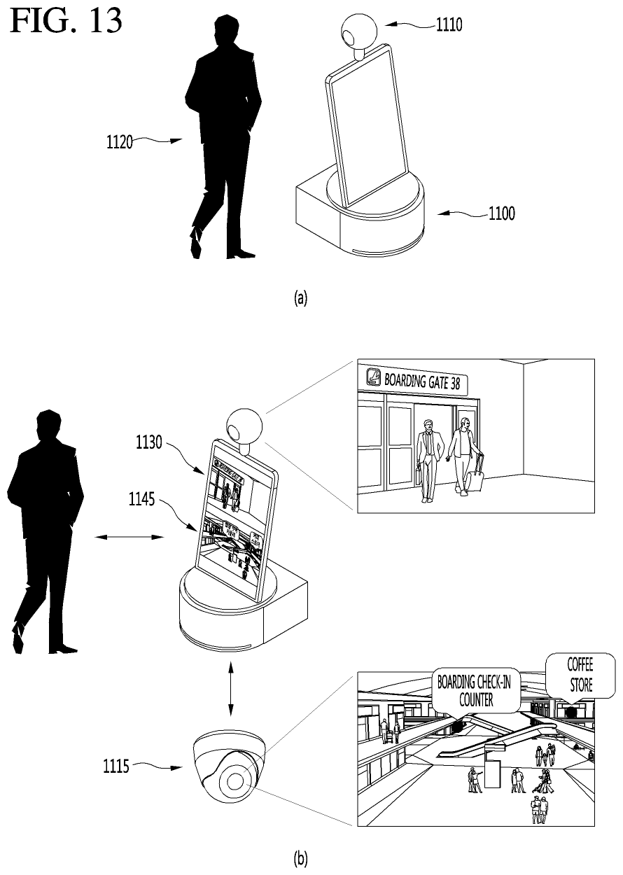

Moreover, as illustrated in FIG. 13, the guidance robot 1100 may perform an image data processing process of adding an indicator representing main facilities in a real-time photographing image 1140 photographed by the CCTV 1155. Therefore, in a case where the user 1120 is provided with a road guidance accompanying service, the user 1120 may be provided with an image 1130 photographed by a front certain region and a CCTV 1115 photographing image where an indicator representing main facilities is displayed.

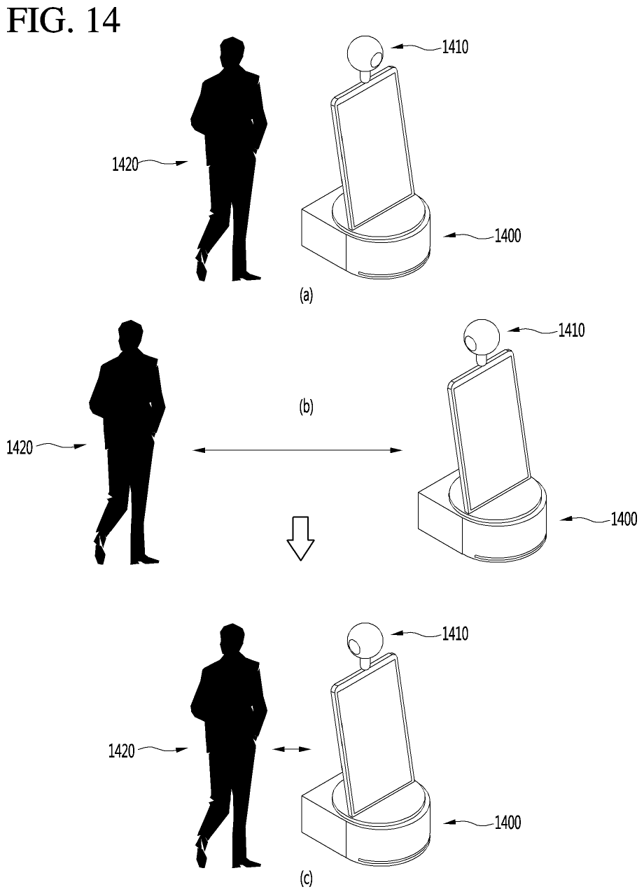

FIGS. 14 to 18 are diagrams for describing an example where a guidance robot according to an embodiment of the present invention always moves while maintaining a certain distance to a user, a wall, and a floor.

The guidance robot according to an embodiment of the present invention may move while maintaining a certain distance to a user, a wall, and a floor. For example, as illustrated in FIG. 14, in a case of providing a user 1420 with a road guidance accompanying service, a guidance robot 1400 may photograph in real time the user 1420 by using an omnidirectional camera 1410. Also, the guidance robot 1400 may measure in real time a distance between the guidance robot 1400 and the user 1420 by using the omnidirectional camera 1410. Also, the guidance robot 1400 may measure in real time a distance between the following user 1420 and the guidance robot 1400 by using an infrared sensor or the like. Also, when the distance between the user 1420 and the guidance robot 1400 becomes equal to or greater than a predetermined distance, the guidance robot 1400 may adjust a speed thereof or may adjust a distance by using a method of approaching the user 1420.

Moreover, in a case of providing the user 1420 with a road guidance accompanying service, the guidance robot 1400 according to an embodiment of the present invention may use a camera for preventing disturbance of an obstacle or a foreign material. The guidance robot 1400 may maintain a constant distance to a wall by using the omnidirectional camera 1410, or may separately include a floor photographing camera and may maintain a constant distance to a floor. Also, a floor distance maintenance device may include a vacuum cleaning means and may suck dust on a floor.

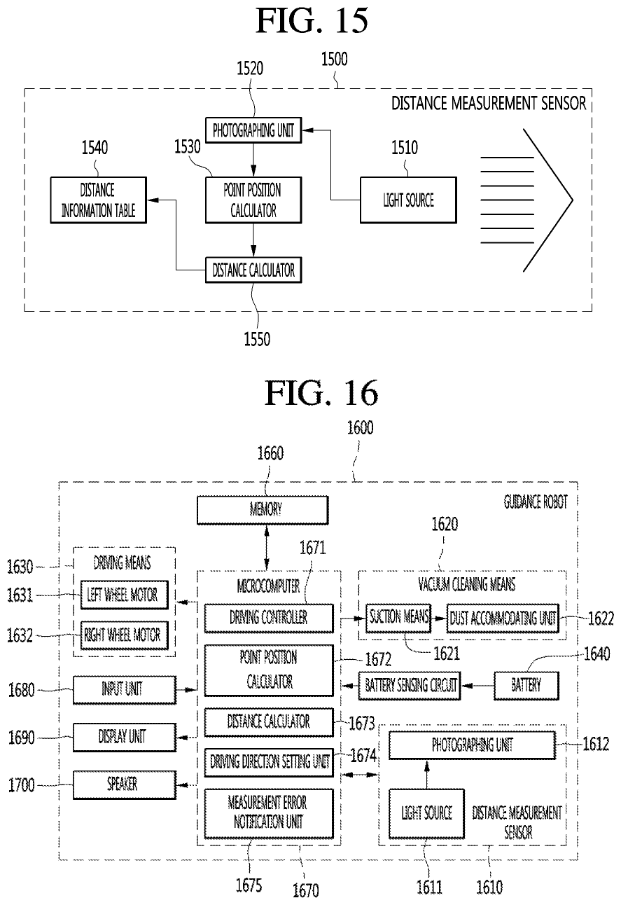

As illustrated in FIG. 15, the guidance robot 1400 according to an embodiment of the present invention may include a distance measurement sensor 1500. The distance measurement sensor 1500 may sense a position change of a point of a beam in a measurement surface, which varies based on a variation of a distance between the measurement surface and a light source 1510 irradiating the beam onto the measurement surface, thereby calculating the distance between the light source 1510 and the measurement surface. The distance measurement sensor 1500 may include the light source 1510 which emits the beam in a direction spaced apart from the measurement surface at a certain angle in a vertical direction of the measurement surface, a photographing unit 1520 which photographs an image of the measurement surface including a point generated in the measurement surface by the light source 1510, a point position calculator 1530 which extracts position information about the point in a measurement surface image photographed by the photographing unit 1520, a distance information table 1540 which stores point position-based distance information in the measurement surface image, and a distance calculator 1550 which calculates and outputs a distance between the measurement surface and the light source 1510 with respect to distance information about a distance between the measurement surface and the light source 1510 corresponding to corresponding point position information from the distance information table 1540, based on position information calculated by the point position calculator 1530. Also, the distance measurement sensor 1500 may include a condensing lens which condenses the beam emitted from the light source 1510, and moreover, the photographing unit 1520 may include one or more lenses for photographing the measurement surface.

The light source 1510 may be configured with, for example, a laser pointer having linearity and a light emitting device such as a light emitting diode (LED) and may be provided to irradiate the beam onto the measurement surface in a distance spaced apart from the vertical distance of the measurement surface by a certain angle. It is preferable that the beam emitted from the light source 1510 has a color capable of being easily differentiated from the measurement surface.

The light source 1510 is vertically installed at a certain angle with respect to the photographing unit 1520 to emit the beam having a certain width, and the emitted beam reaches the measurement surface to generate a point. The reason that the light source 1510 is vertically installed at a certain angle is for that a position of the point varies based on a distance variation between the light source 1510 and the measurement surface.

According to an aspect of the present invention, the light source 1510 according to the present invention may include an LED and a light condensing unit which condenses light, emitted from the LED, into a beam having a certain width and linearity. Generally, since the light emitted from the LED is light which is emitted without linearity, a certain point may be generated in the measurement surface. Therefore, the light condensing unit may condense the light, emitted from the LED, into the beam having a certain width and linearity. The light condensing unit may be implemented as an array of one or more lenses, but in a preferable embodiment of the present invention, the light condensing unit may be coupled to the LED and may be configured with a cover where a hole having a certain size is provided. The cover may be formed of a material through which light cannot pass, and the light emitted from the LED may be irradiated through the hole, thereby allowing a beam having linearity to be output through only simple coupling of the cover.

The photographing unit 1520 may be a light sensor which is provided in parallel with the measurement surface and photographs and outputs an image of the measurement surface including a point generated from a beam in the measurement surface. The photographing unit 1520 may photograph a measurement surface image including a point varying based on a distance between the light source 1510 and the measurement surface and may output the measurement surface image to the point position calculator 1530.

The point position calculator 1530 may receive the measurement surface image output through the photographing unit 1520 to extract a point from the measurement surface image and may calculate position information from the measurement surface image of the extracted point to output the calculated position information to the distance calculator 1550. The point position calculator 1530 may extract a point generated from another beam having a color differing from that of the measurement surface by using a color information difference with the measurement surface, calculate a position at which the point is generated in the measurement surface image, and transmit the calculated position information to the distance calculator.

The distance information table 1540 may be configured with, for example, flash memory which has a compact size and is readable and writable. The distance information table 1540 may store distance information about a distance between the light source 1510 and the measurement surface by units of point positions in a measurement surface image previously calculated through an experiment. In this manner, access to stored data may be controlled by the distance calculator 1550.

The distance calculator 1550 may receive position information about a point output from the point position calculator 1530, access a distance between the light source 1510 and the measurement surface by using corresponding distance information from the distance information table, and provide the distance.

Based on a correlation of a position change of a point based on a distance variation between the light source 1510 and the measurement surface, the distance calculator 1550 calculates distance information about a distance between the light source 1510 and the measurement surface. In point position-based distance information, as described above, measurement information calculated through an experiment may be sampled and stored in the distance information table 1540, and the distance calculator 1550 may access distance information corresponding to corresponding position information from the distance information table 1540 by using position information about a point calculated by the point position calculator 1530 and may output the accessed distance information.

As illustrated in FIG. 16, the guidance robot 1600 according to the present invention may include a vacuum cleaning means 1620 which perform cleaning of a floor along with a driving module near the floor. Also, the guidance robot 1600 may include a distance measurement sensor 1610 which irradiates a beam onto the measurement surface to sense and output a measurement surface image including a point generated from the beam and a microcomputer 1670 which calculates a distance between the distance measurement sensor 1610 and the measurement surface based on a position change of a beam point in the measurement surface image output from the distance measurement sensor 1610.

The distance measurement sensor 1610 may include a light source 1611 which irradiates the beam onto the measurement surface to sense and output the measurement surface image including the point generated from the beam and emits the beam in a direction spaced apart from the measurement surface at a certain angle in the vertical direction of the measurement surface and a photographing unit 1612 which photographs the measurement surface image including a beam point generated in the measurement surface by the beam irradiated from the light source 1611 and outputs the measurement surface image to the microcomputer 1670. Also, the distance measurement sensor 1610 may include a condensing lens which condenses a beam emitted from the light source 1611, and moreover, the photographing unit 1612 may include one or more lenses for photographing the measurement surface.

The light source 1611 may be configured with, for example, a laser pointer having linearity and a light emitting device such as an LED and may be provided to irradiate the beam onto the measurement surface in a distance spaced apart from the vertical distance of the measurement surface by a certain angle. It is preferable that the beam emitted from the light source 1611 has a color capable of being easily differentiated from the measurement surface.

The light source 1611 is installed vertically at a predetermined angle with respect to the photographing unit 1612 to emit a beam having a predetermined width, and the emitted beam reaches a measurement surface to generate a point. The reason why the light source 1611 is installed vertically at the predetermined angle is to vary the position of the point according to the distance change between the light source 1611 and the measurement surface.

The photographing unit 1612 may be a light sensor which is provided in parallel with the measurement surface and photographs and outputs an image of the measurement surface including a point generated from a beam in the measurement surface. The photographing unit 1612 may photograph a measurement surface image including a point varying based on a distance between the light source 1611 and the measurement surface and may output the measurement surface image to the microcomputer 1670.

To describe a fundamental configuration of the guidance robot 1600 of FIG. 16, the guidance robot 1600 may include a vacuum cleaning means 1620 which includes a dust sensor for sensing dust or foreign materials in a cleaning zone, a suction means 1621 for sucking the dust or the foreign materials sensed by the dust sensor, and a dust accommodating means 1622 for accommodating the dust and foreign materials collected by the suction means 1621, a driving means 1630 for driving a cleaning robot 1600, a battery 1640 for supplying a driving power to the vacuum cleaning means 1620 and the driving means 1630, a battery sensing circuit 1650 which senses a remaining amount of the battery 1640 at every certain period, and when a value of the remaining amount is equal to or less than a predetermined value, outputs a battery charging request signal, a memory 1660 for storing a driving program of the cleaning robot 1600 and position information about a charging stand calculated from a guidance signal, an input unit 1680 for receiving a manipulation command of a user, and a display unit 1690 for displaying a driving state of the cleaning robot.

The memory 1660 is configured with, for example, a non-volatile memory device such as electrically erasable programmable read-only memory (EEPROM) or flash memory and stores an operating program for driving of the guidance robot 1600. Also, according to an aspect of the present invention, the memory 1660 stores point position-based distance information in a measurement surface image. As described above, in the point position-based distance information, measurement information calculated through an experiment is sampled and stored, and access to such data is controlled by the microcomputer 1670.

The driving means 1630 drives a right wheel motor 1621 and a left wheel motor 1622 according to a control signal output from the microcomputer 1670 to drive a movement robot 1600. The right wheel motor 1621 and the left wheel motor 1622 of the driving means 1630 may be connected to left and right wheels for driving the movement robot 1600. Accordingly, the movement robot 1600 may drive in all directions, based on a rotation speed and a rotation direction of each of the right wheel motor 1621 and the left wheel motor 1622.

The microcomputer 1670 controls overall operations of most elements of the movement robot 1600 according to the operating program stored in the memory 1660 and calculates a distance between the distance measurement sensor 1610 and the measurement surface based on a position change of a beam point in a measurement surface image output from the distance measurement sensor 1610, and depending on the case, the microcomputer 1670 re-sets a driving direction.

A function of the microcomputer 1670 is one of function modules of the operating program installed in the movement robot 1600 and may be simply implemented with a software language.

The microcomputer 1670 may include a driving controller 1671 which controls driving of the driving means 1630, a position calculator 1672 which receives a measurement surface image output from the distance measurement sensor 1610 to extract a point from the measurement surface image and calculates a position of the extracted point, and a distance calculator 1673 which calculates a distance between the distance measurement sensor 1610 and the measurement surface with reference to distance information, corresponding to corresponding point position information, in the memory 1660 through the position information calculated by the point position calculator 1672.

The driving controller 1671 may control the driving means 1630 driving the movement robot 1600 according to a control command output from the operating program of the movement robot 1600.

The point position calculator 1672 receives the measurement surface image output through the photographing unit 1612, extracts a point from the measurement surface image, calculates position information in the measurement surface image of the extracted point, and outputs the calculated position information to the distance calculator 1673. The point position calculator 1672 extracts a point generated from another beam having a color differing from that of the measurement surface by using a color information difference with the measurement surface, calculates a position at which the point is generated in the measurement surface image, and transmits the calculated position information to the distance calculator.

The distance calculator 1673 may receive position information about a point output from the point position calculator 1672, access a distance between the light source 1611 and the measurement surface by using corresponding distance information from the memory 1660, and output the distance.

According to an aspect of the present invention, in the guidance robot 1600 according to the present invention, the above-described distance measurement sensor 1610 may be installed on a lower surface, may determine an operation-disabled region such as a door sill where a height between an obstacle and each of a floor and the movement robot 1600, based on the distance information measured by the distance calculator 1673, and may deviate from a corresponding region. Therefore, the microcomputer 1670 according to the present invention may further include a driving direction setting unit 1674 which, when a distance between measurement surfaces calculated by the distance calculator 1673 is outside a predetermined error range, determines an obstacle, re-sets a driving direction, and outputs a control signal to the driving controller 1671 in order for the guidance robot 1600 to drive in the re-set driving direction.

The driving direction setting unit 1674 may receive distance information output from the distance calculator 1673 to determine whether the distance information is within an error range of predetermined reference distance information, and when it is determined that the distance information is outside the error range of the predetermined reference distance information, the driving direction setting unit 1674 may determine that a region where the guidance robot 1600 is driving is an operation-disabled region or an obstacle region, re-set a driving direction to deviate from a corresponding region, and output the control signal to the driving controller 1671 in order for the guidance robot 1600 to drive in the re-set driving direction.

Therefore, the guidance robot 1600 according to the present invention calculates accurate distance information about a distance between the guidance robot 1600 and a floor by using the distance measurement sensor 1610 enabling proximity distance measurement and more accurately determines a region where a height varies due to a structure, and thus, has an advantage for avoiding the region.

According to an aspect of the present invention, in the guidance robot 600 according to the present invention, the above-described distance measurement sensor 1610 may be installed on a side surface of the guidance robot 1600, and in wall following driving, the guidance robot 600 may drive at a certain interval from a corresponding wall. Therefore, the driving direction setting unit 1674 of the microcomputer 1670 according to the present invention may compare distance information with a distance to the measurement surface calculated by the distance calculator 1673 to re-set a driving direction so that the distance to the measurement surface is maintained within an error range of set distance information, and may output a control signal to the driving controller 1671 in order for the guidance robot 1600 to drive in the re-set driving direction.

The driving direction setting unit 1674 may receive distance information between the guidance robot 1600 and a wall output from the distance calculator 1673 to determine whether the distance information is within an error range of predetermined reference distance information, and when it is determined that the distance information is outside the error range of the predetermined reference distance information, the driving direction setting unit 1674 may maintain a driving direction of the guidance robot 1600. When it is determined that the distance information is outside the error range of the predetermined reference distance information, the driving direction setting unit 1674 may re-set a driving direction of the guidance robot 1600 so that a distance to the wall is maintained within the error range of the predetermined reference distance information, and may output the control signal to the driving controller 1671 in order for the guidance robot 1600 to drive in the re-set driving direction.

Therefore, the guidance robot 1600 according to the present invention calculates accurate distance information about a distance between the guidance robot 1600 and a floor by using the distance measurement sensor 1610 enabling proximity distance measurement, and in wall following driving where the guidance robot 1600 drives along a wall, there is an advantage where the guidance robot 1600 drives while maintaining a certain interval.

According to an aspect of the present invention, in the guidance robot 1600 according to the present invention, in a case where the above-described distance measurement sensor 1610 is in a measurement-disabled region, the guidance robot 1600 notifies a server or a manager of the case. Therefore, the microcomputer 1670 according to the present invention may further include a measurement error notification unit 1675 which, when there is no point in a measurement surface image by the point position calculator 1672, notifies the server or the manager of a measurement error through the speaker 1700 or the display unit 1690.

In a case where the point position calculator 1672 extracts a point from an image of a measurement surface transmitted from the photographing unit 1612, when the point is not in the image of the measurement surface and thus it is unable to extract a position of the point, the point position calculator 1672 may output an error signal to the measurement error notification unit 1675. When the point is not in the image of the measurement surface, it may be determined that a distance between the distance measurement sensor 1610 and the measurement surface is outside a photographing region of the photographing unit 1612. Accordingly, the measurement error notification unit 1675 may receive the error signal and may output a voice or graphics data through the speaker 1700 or the display unit 1690 included in the guidance robot 1600, thereby notifying a user of a measurement error.

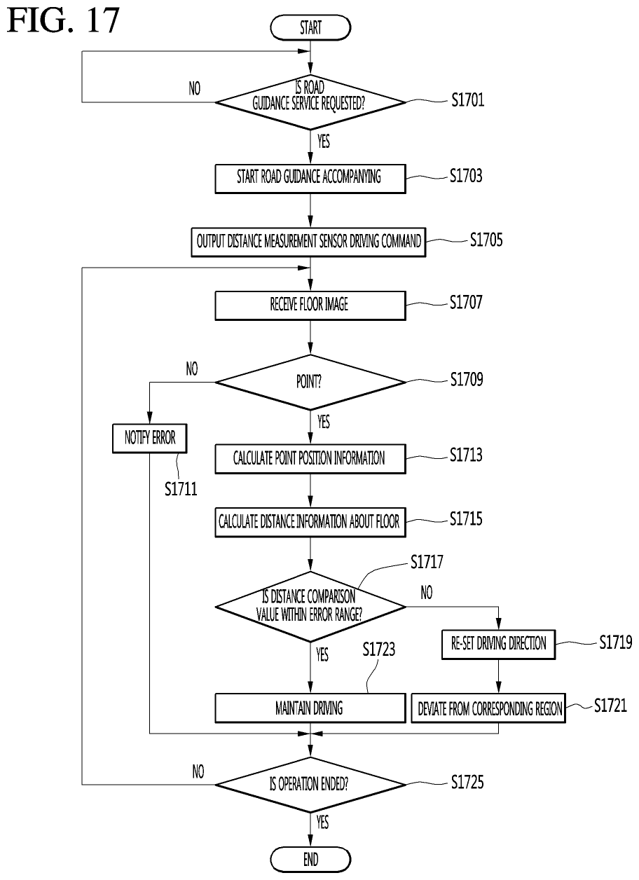

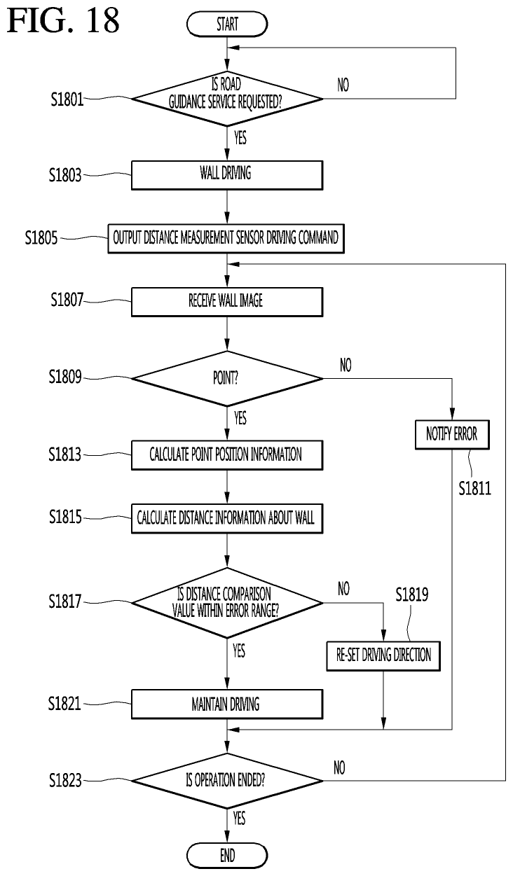

Hereinafter, a driving method of a guidance robot using the distance measurement sensor 1610 according to an embodiment of the present invention will be described in more detail with reference to FIGS. 17 and 18.

FIG. 17 is a flowchart schematically illustrating a driving process of a guidance robot according to a preferable embodiment of the present invention. As illustrated in FIG. 17, a driving method of a guidance robot driving along a wall may include a step of receiving a wall image from the distance measurement sensor 1610 outputting the wall image including a point generated by a beam irradiated onto a wall, a step of extracting the point from the wall image to calculate extracted point position information, a step of calculating a distance between the distance measurement sensor 1610 and the wall with reference to distance information corresponding to corresponding point position information from the memory 1610 storing point position-based distance information in the wall image through the calculated point position information, and a step of comparing predetermined distance information with the calculated distance to the wall to re-set a driving direction so that a distance between the guidance robot 1600 and the wall is maintained within an error range of the predetermined distance information, and outputting a control signal in order for the guidance robot 1600 to drive in the re-set driving direction.

According to an aspect of the present invention, the driving method of the guidance robot 1600 according to the present invention may further include a step of, when a point is not extracted from a floor, notifying a user of a measurement error through the speaker 1700 or the display unit 1690.

When the user requests road guidance from the guidance robot 1600 (S1701), the guidance robot 1600 starts a road guidance accompanying service along with a road guidance service as described above (S1703).

At this time, the microcomputer 1670 may transmit a driving command to one or more distance measurement sensors 1610 provided on a lower surface of the guidance robot 1600 (S1705). The distance measurement sensor 1610 may irradiate, through the light source 1611, a beam having a certain width onto the floor according to the driving command, and the photographing unit 1612 may photograph a floor image including a point generated in the floor by the beam to output the floor image to the point position calculator 1672 of the microcomputer 1670 (S1707).

The point position calculator 1672 may receive the floor image output from the distance measurement sensor 1610 to extract a point from the floor image and may calculate position information from a measurement surface image of the extracted point to output the calculated position information to the distance calculator 1673 (S1713).

The distance calculator 1673 may receive the position information about the point output from the point position calculator 1672, access a distance between the light source 1611 and the measurement surface by using corresponding distance information from the memory 1660, and output the distance to the driving direction setting unit 1674 (S1715).

The driving direction setting unit 1674 may receive the distance information output from the distance calculator 1673 to determine whether the received distance information is within an error range of predetermined reference distance information (S1717), maintain driving when it is determined that the received distance information is within the error range of the predetermined reference distance information (S1723), determine a region, where the guidance robot 1600 is driving, as an operation-disabled region or an obstacle region when the received distance information is outside the error range of the predetermined reference distance information and re-set a driving direction to deviate from a corresponding region (S1719), and output a control signal to the driving controller 1671 in order for the guidance robot 1600 to drive in the re-set driving direction (S1721). When road guidance ends, the movement robot 1600 stops driving thereof (S1725), and in a case of re-setting a driving direction, the movement robot 1600 may newly calculate a movement path for road guidance.

When a point is not in an image of a floor transmitted from the photographing unit 1612 and thus it is unable to extract a position of the point (S1709), the point position calculator 1672 outputs an error signal to the measurement error notification unit 1675. When the point is not in the image of the floor, it may be determined that a distance between the distance measurement sensor 1610 and the measurement surface is outside a photographing region of the photographing unit 1612. Accordingly, the measurement error notification unit 1675 may receive the error signal and may output a voice or graphics data through the speaker 1700 or the display unit 1690 included in the guidance robot 1600, thereby notifying a user of a measurement error. (S1711)

FIG. 18 is a flowchart schematically illustrating a driving process in road guidance by a guidance robot according to a second embodiment of the present invention. As illustrated in FIG. 18, a driving method in road guidance by a guidance robot according to the present invention may include a step of receiving a wall image from the distance measurement sensor 1610 outputting the wall image including a point generated by a beam irradiated onto a wall, a step of extracting the point from the wall image to calculate extracted point position information, a step of calculating a distance between the distance measurement sensor 1610 and the wall with reference to distance information corresponding to corresponding point position information from the memory 1610 storing point position-based distance information in the wall image through the calculated point position information, and a step of comparing predetermined distance information with the calculated distance to the wall to re-set a driving direction so that a distance between the guidance robot 1600 and the wall is maintained within an error range of the predetermined distance information, and outputting a control signal in order for the guidance robot 1600 to drive in the re-set driving direction.

According to an aspect of the present invention, the driving method of the guidance robot 1600 according to the present invention may further include a step of, when a point is not extracted from a floor, notifying a user of a measurement error through the speaker 1700 or the display unit 1690.

When the user requests road guidance from the guidance robot 1600 (S1801), the guidance robot 1600 starts a road guidance accompanying service by using wall driving along with a road guidance service as described above (S1803).

At this time, the microcomputer 1670 may transmit a driving command to one or more distance measurement sensors 1610 provided on a side surface of the guidance robot 1600 (S1805). The distance measurement sensor 1610 may irradiate, through the light source 1611, a beam having a certain width to the wall according to the driving command, and the photographing unit 1612 may photograph a wall image including a point generated in the wall by the beam to output the wall image to the point position calculator 1672 of the microcomputer 1670 (S1807).

The point position calculator 1672 may receive the wall image output from the distance measurement sensor 1610 to extract a point from the wall image and may calculate position information from a measurement surface image of the extracted point to output the calculated position information to the di stance calculator 1673 (S1813). The di stance calculator 1673 may receive the position information about the point output from the point position calculator 1672, access a distance between the light source 1611 and the measurement surface by using corresponding distance information from the memory 1660, and output the distance to the driving direction setting unit 1674 (S1815).

The driving direction setting unit 1674 may receive the distance information about a distance between the guidance robot 1600 and the wall output from the distance calculator 1673 to determine whether the received distance information is within an error range of predetermined reference distance information (S1817), maintain a driving direction of the guidance robot 1600 when it is determined that the received distance information is within the error range of the predetermined reference distance information (S1821), and when the received distance information is outside the error range of the predetermined reference distance information, the driving direction setting unit 1674 may re-set a driving direction of the guidance robot 1600 so that a distance to the wall is maintained within the error range of the predetermined reference distance information and may output a control signal to the driving controller 1671 in order for the guidance robot 1600 to drive in the re-set driving direction (S1819). When road guidance ends, the movement robot 1600 may stop driving thereof (S1823).

When a point is not in an image of a wall transmitted from the photographing unit 1612 and thus it is unable to extract a position of the point, the point position calculator 1672 outputs an error signal to the measurement error notification unit 1675. When the point is not in the image of the wall, it may be determined that a distance between the distance measurement sensor 1610 and the measurement surface is outside a photographing region of the photographing unit 1612 (S1809). Accordingly, the measurement error notification unit 1675 may receive the error signal and may output a voice or graphics data through the speaker 1700 or the display unit 1690 included in the guidance robot 1600, thereby notifying a user of a measurement error. (S1811)

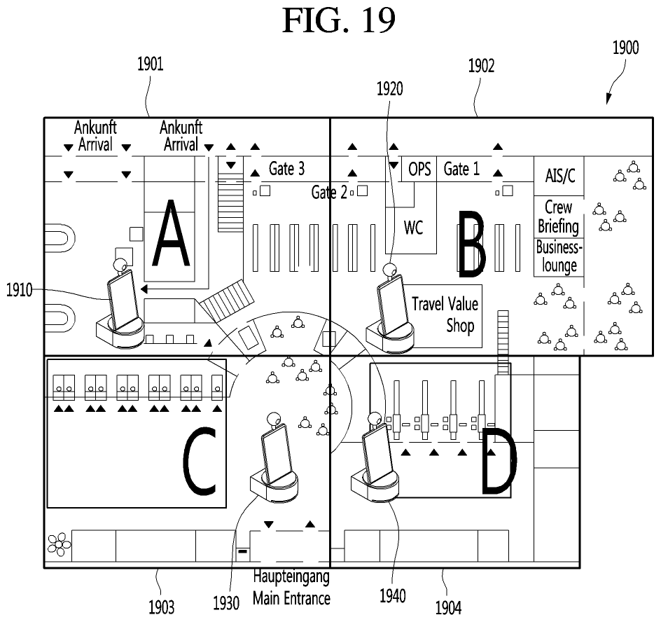

FIGS. 19 to 21 are diagrams for describing an example where guidance robots according to an embodiment of the present invention provide an accompanying road guidance service by units of regions.

As illustrated in FIG. 19, guidance robots 1910 to 1940 according to an embodiment of the present invention may be disposed in a certain region of an inner portion 1900 of airport. In this case, the inner portion 1900 of the airport may be divided into certain regions 1901 to 1904, and the guidance robots 1910 to 1940 may be set to move in only a predetermined region. For example, a first guidance robot 1910 may move in only a first region 1901 of the inner portion 1900 of the airport. Also, a second guidance robot 1920 may move in only a second region 1902 of the inner portion 1900 of the airport. Also, a third guidance robot 1930 may move in only a third region 1903 of the inner portion 1900 of the airport. Also, a fourth guidance robot 1940 may move in only a fourth region 1904 of the inner portion 1900 of the airport.

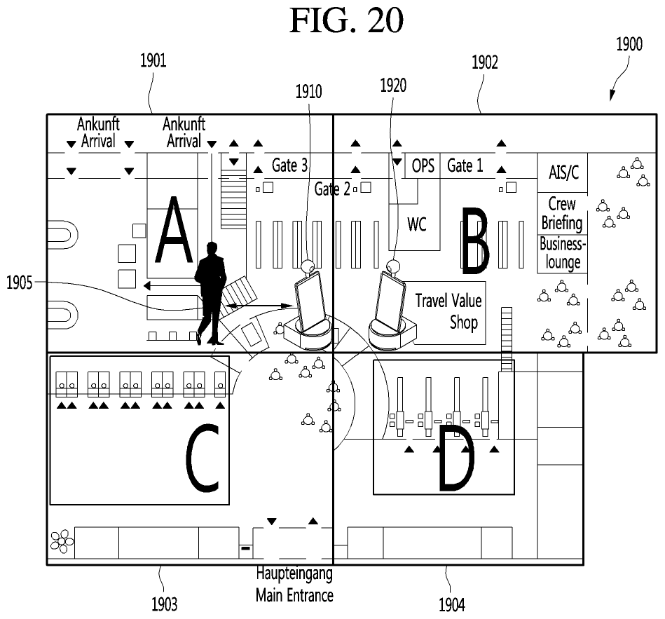

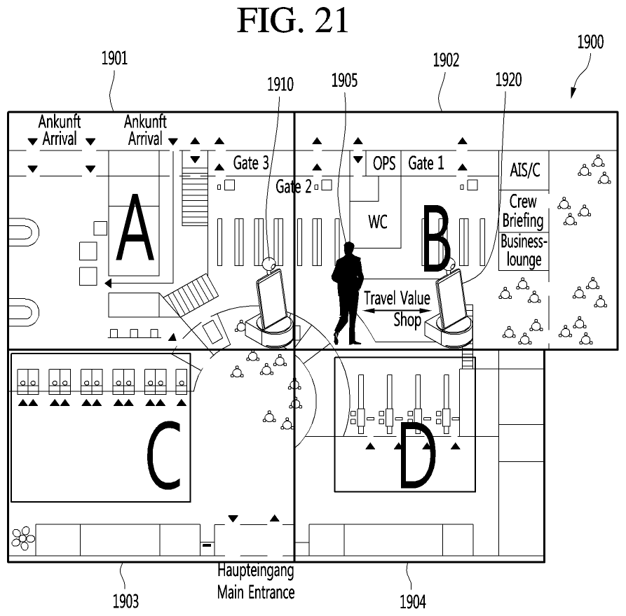

When the guidance robot is set to move in only a predetermined region, the guidance robots 1910 to 1940 may accompany a user up to only a position at which each of the guidance robots 1910 to 1940 is outside a movable region. Also, the guidance robots may communicate with one another so that another guidance robot accompanies a user from a time when each guidance robot deviates from a movable region. For example, as illustrated in FIG. 20, a user 1905 may request a road guidance accompanying service from the first guidance robot 1910 in the first region 1901. At this time, it is assumed that a movement path to a destination requested by the user 1905 passes through the second region 1902 via the first region 1901. In this case, the first guidance robot 1910 may accompany the user 1905 up to only a boundary of the first region 1901 where the first guidance robot 1910 is movable. Also, as illustrated in FIG. 21, the first guidance robot 1910 may transmit a message, which allows a second guidance robot 1920 to continually accompany the user 1905, to the second guidance robot 1920. In this case, the first guidance robot 1910 may transmit, to the second guidance robot 1920, a message including image data obtained by photographing the user 1905, movement path information about the user 1905, and navigation data. The second guidance robot 1920 receiving the message from the first guidance robot 1910 may accompany the user 1905 and may provide a road guidance service from a start point of the second region 1902 in a movement path.

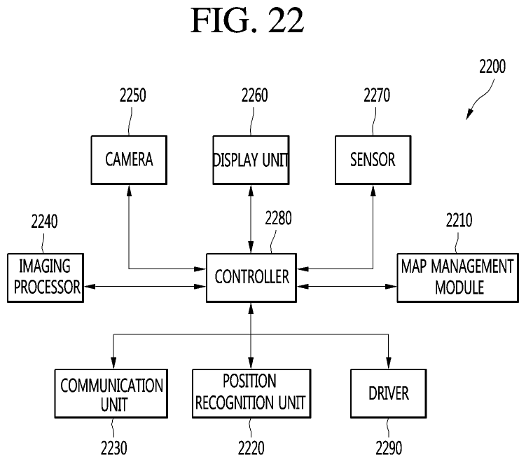

FIG. 22 is a block diagram illustrating a configuration of a guidance robot for airport according to an embodiment of the present invention. To describe the guidance robot for airport according to an embodiment of the present invention described above with reference to FIGS. 4 to 21, the block diagrams illustrated in FIGS. 1 and 2 may be simplified like FIG. 22.

A guidance robot 2200 for airport according to an embodiment of the present invention may include a map management module 2210 which stores airport map data. Also, the guidance robot 2200 for airport may include a camera 2250 which photographs an image. Also, the guidance robot 2200 for airport may include a communication unit 2230 which transmits or receives data. Also, the guidance robot 2200 for airport may include an imaging processor 2240 which processes an image. Also, the guidance robot 2200 for airport may include a display unit 2260 which outputs the processed image. Also, the guidance robot 2200 for airport may include a driver 2290 which moves the guidance robot 2200 for airport. Also, the guidance robot 2200 for airport may include a controller 2280. Also, when a road guidance request signal is received, the controller 2280 may calculate a movement path from a current position to a destination. Also, the guidance robot 2200 for airport may move along a movement path. The camera 2250 may photograph a real-time image of a certain region of the movement path. Also, the controller 2280 may perform control to display the photographed real-time image on the display unit 2260. Also, the controller 2280 may generate navigation content based on the movement path. Also, the controller 2280 may perform control to display the photographed real-time image and the navigation content on the display unit 2260 in a screen division mode. Also, the controller 2280 may generate the navigation content based on the movement path. Also, based on a user selection input, the controller 2280 may perform control to alternately display the photographed real-time image and the navigation content on the display unit 2260. Also, the guidance robot 2200 for airport may further include a position recognition unit 2220. The position recognition unit 2220 may include a LiDAR module and a Wi-Fi module. Also, the controller 2280 may detect a current position of the guidance robot 2200 through the position recognition unit 2220. Also, the controller 2280 may calculate a movement path by using detected current position information and destination information. The communication unit 2230 may receive CCTV photographing image data obtained by photographing the movement path. Also, the controller 2280 may perform control to display a photographed real-time image and a received CCTV photographing image on the display unit 2260 in the screen division mode. The communication unit 2230 may receive CCTV photographing image data obtained by photographing a periphery of a destination. Also, the controller 2280 may perform control to display the photographed real-time image and the received CCTV photographing image on the display unit 2260 in the screen division mode. The communication unit 2230 may receive main facilities data of a periphery of the destination from the server. Also, the controller 2280 may perform control so that the CCTV photographing image data and the main facilities data of the periphery of the destination are mixed and displayed on the display unit 2260. The camera 2250 may photograph a user in real time. Also, the controller 2280 may calculate in real time a distance between the user and the guidance robot 2200 for airport by using a user image photographed in real time. Also, the controller 2280 may adjust in real time a driving speed of the driver 2290 so that the distance between the user and the guidance robot 2200 is within a predetermined range. The guidance robot 2200 for airport may include a sensor 2270 which senses the distance between the user and the guidance robot 2200 in real time. Also, the controller 2280 may adjust in real time the driving speed of the driver 2290 so that the distance between the user and the guidance robot 2200 is within the predetermined range.

A guidance robot for airport according to another embodiment of the present invention may include a map management module 2210 which stores airport map data. Also, the guidance robot 2200 for airport may include a sensor 2270 which senses a position change of a point of a beam in a measurement surface changed based on a distance variation between the measurement surface and a light source irradiating the beam onto the measurement surface to calculate a distance between the light source and the measurement surface. Also, the guidance robot 2200 for airport may include a communication unit 2230 which transmits or receives data. Also, the guidance robot 2200 for airport may include an imaging processor 2240 which processes an image. Also, the guidance robot 2200 for airport may include a display unit 2260 which outputs the processed image. Also, the guidance robot 2200 for airport may include a driver 2290 which moves the guidance robot 2200 for airport. Also, the guidance robot 2200 for airport may include a controller 2280. Also, when a road guidance request signal is received from a user, the sensor 2270 may sense in real time a distance between the user and the guidance robot for airport. Also, the controller 2280 may calculate a movement path from a current position to a destination. Also, the guidance robot 2200 for airport may move along a movement path. Also, the controller 2280 may adjust in real time a driving speed of the driver 2290 so that the distance between the user and the guidance robot 2200 is within a predetermined range. A light source of the sensor 2270 may include an LED and a light condensing unit which condenses light, emitted from the LED, into a beam. The light source of the sensor 2270 may be a laser. Also, the sensor 2270 may be provided on a side surface of the guidance robot 2200 for airport.

In a computer-readable storage medium including computer-executable instructions executed by a processing system, the computer-executable instructions for providing a road guidance service according to an embodiment of the present invention may include instructions for receiving a road guidance request signal, instructions for calculating a movement path from a current position to a destination, instructions for moving along the movement path, instructions for photographing a real-time image of a certain region of the movement path through a camera, and instructions for displaying the photographed real-time image on the display unit. Also, the computer-executable instructions may include instructions for generating navigation content based on the movement path and instructions for displaying the photographed real-time image and the navigation content on the display unit in the screen division mode. Also, the computer-executable instructions may include instructions for generating the navigation content based on the movement path and instructions for alternately displaying the photographed real-time image and the navigation content on the display unit according to a user selection input. Also, the computer-executable instructions may include instructions for detecting a current position of the guidance robot for airport through a position recognition unit and instructions for calculating the movement path by using the detected current position information and destination information. Also, the computer-executable instructions may include instructions for receiving CCTV photographing image data obtained by photographing the movement path through a communication unit and instructions for displaying the photographed real-time image and a received CCTV photographing image on the display unit in the screen division mode. Also, the computer-executable instructions may include instructions for receiving CCTV photographing image data obtained by photographing a periphery of a destination through the communication unit and instructions for displaying the photographed real-time image and the received CCTV photographing image on the display unit 2260 in the screen division mode. Also, the computer-executable instructions may include instructions for receiving main facilities data of a periphery of the destination from the server through the communication unit and instructions for mixing the CCTV photographing image data and the main facilities data of the periphery of the destination to display mixed data on the display unit.

According to an embodiment of the present invention, the above-mentioned method can be embodied as computer readable codes on a non-transitory computer readable recording medium having a program thereon. Examples of the computer readable recording medium include ROM, RAM, CD-ROM, magnetic tape, floppy disk, and an optical data storage device. Also, the computer can include an AP 150 of the robot for airport. The above-described display device is not limited to the application of the configurations and methods of the above-described embodiments and the entire or part of the embodiments can be selectively combined and configured to allow various modifications.

1. A guidance robot comprising:
a map management module configured to store map data;
a camera configured to capture an image;
a communication interface configured to transmit or receive data;
a display configured to display an image;
a motor configured to generate a force to move the guidance robot; and
a controller configured to control an operation of the guidance robot,
wherein in response to receiving a road guidance request signal, the controller is to control the display to display a real-time image of a region of a movement path captured by the camera while moving along a determined movement path from a current position to a destination position, based on the map data.

2. The guidance robot of claim 1, wherein the controller is to provide navigation content based on the movement path and is to control the display to display, in a screen division mode, the real-time image and the navigation content.

3. The guidance robot of claim 1, wherein the controller is to provide navigation content based on the movement path and is to control the display to alternately display, based on a user selection input, the real-time image and the navigation content.

4. The guidance robot of claim 1, further comprising a position recognition unit configured to detect a position of the guidance robot,
wherein the controller is to determine the movement path by using current position information regarding the position detected by the position recognition unit and destination information about the destination position.

5. The guidance robot of claim 1, wherein the controller is to receive, through the communication interface, photographing image data obtained by capturing the movement path and is to control the display to display, in a screen division mode the real-time image and a photographing image corresponding to the photographing image data.

6. The guidance robot of claim 1, wherein the controller is to receive, through the communication interface, photographing image data obtained by capturing a periphery of the destination position and is to control the display to display, in a screen division mode, the real-time image and a photographing image corresponding to the photographing image data.

7. The guidance robot of claim 6, wherein
the communication interface is to receive, from a server, main facilities data of a periphery of the destination position, and
the controller is to combine the photographing image data with the main facilities data and display combined data on the display.

8. The guidance robot of claim 1, wherein
the camera is to capture a user image of a user in real time, and
the controller is to determine in real time a distance between the user and the guidance robot based on the user image, and is to control in real time a driving speed of the motor such that the distance between the user and the guidance robot is maintained within a predetermined range.

9. The guidance robot of claim 1, further comprising a sensor configured to sense, in real time, a distance between the user and the guidance robot,
wherein the controller is to control in real time a driving speed of the motor so that the distance between the user and the guidance robot is maintained within a predetermined range.

10. A guidance robot comprising:
a map management module configured to store map data;
a sensor device configured to sense a position change of a beam on a measurement surface, wherein the beam is to change based on a variation of a distance between the measurement surface and a light source that irradiates the beam onto the measurement surface, and determines a distance between the light source and the measurement surface;
a communication interface configured to transmit or receive data;
a display configured to display an image;
a motor configured to generate a force to move the guidance robot; and
a controller configured to control an operation of the guidance robot,
wherein,
in response to receiving a road guidance request signal, the controller is to control the sensor device to sense, in real time, a distance between a user and the guidance robot and is to control in real time a driving speed of the motor such that the distance between the user and the guidance robot is maintained within a predetermined range while moving along a determined movement path from a current position to a destination position, based on the map data.

11. The guidance robot of claim 10, wherein the light source comprises an LED and a light condensing unit configured to condense light, emitted from the LED, into a beam.

12. The guidance robot of claim 10, wherein the light source is a laser.

13. The guidance robot of claim 10, wherein the sensor is provided on a side surface of the guidance robot.

14. A non-transitory computer-readable storage medium including computer-executable instructions executed by a processing system, the computer-executable instructions for providing a road guidance service comprising:
instructions for receiving a road guidance request signal;
instructions for determining a movement path from a current position to a destination position;
instructions for moving along the movement path;
instructions for controlling a camera to capture a real-time image of a region of the movement path; and
instructions for controlling a display to display the captured real-time image.

15. The computer-readable storage medium of claim 14, further comprising:
instructions for providing navigation content based on the movement path; and
instructions for controlling the display to display, in a screen division mode, the captured real-time image and the navigation content.

16. The computer-readable storage medium of claim 15, further comprising:
instructions for providing the navigation content based on the movement path; and
instructions for controlling the display to alternately display, based on a user selection input, the captured real-time image and the navigation content.

17. The computer-readable storage medium of claim 14, further comprising:
instructions for detecting a position of a guidance robot based on a position recognition device; and
instructions for determining the movement path by using the detected position information and destination information.

18. The computer-readable storage medium of claim 14, further comprising:
instructions for receiving, through a communication interface, photographing image data obtained by capturing the movement path; and
instructions for controlling the display to display, in a screen division mode, the captured real-time image and a received photographing image.

19. The computer-readable storage medium of claim 14, further comprising:
instructions for receiving, through a communication interface, photographing image data obtained by capturing a periphery of the destination position; and
instructions for controlling the display to display, in a screen division mode, the captured real-time image and the received photographing image.

20. The computer-readable storage medium of claim 19, further comprising:
instructions for receiving, through the communication interface, main facilities data of a periphery of the destination position from a server; and
instructions for combining the photographing image data and the main facilities data of the periphery of the destination position to display combined data on the display.
